(19) United States
(12) Patent Application Publication
(10) Pub. No.: US 2009/0135333 A1
(43) Pub. Date: May 28, 2009

(54) LCD with ambient light sense function and method thereof

(75) Inventors: Ya-Hsiang Tai, Hsinchu City (TW); Han-Ching Ho, Taipei City (TW); Chia-Pin Cheng, Kaohsiung County (TW)

Correspondence Address: BACON & THOMAS, PLLC, 625 SLATERS LANE, FOURTH FLOOR, ALEXANDRIA, VA, 22314-1176, US

(73) Assignee: NATIONAL CHIAO TUNG UNIVERSITY, Hsinchu City (TW)

(21) Appl. No.: 12/073,485

(22) Filed: Mar. 6, 2008

(30) Foreign Application Priority Data
Nov. 27, 2007 (TW) 096145046

(51) Int. Cl. G02F 1/1335; H05B 37/02

(52) U.S. Cl. 349/61; 250/214 AL

(57) ABSTRACT

The invention discloses an LCD with an ambient light sense function and its method. The method compraises the step of: coupling a capacitor to a source electrode of a thin film transistor; calculating a transmission time which required by a potential change from the reduction of electric charges; and finally, calculating an intensity of the ambient light according to the transmission time. The invention further discloses an ambient light sense circuit having a thin film transistor, a capacitor and a read-out switch. As the ambient light changes, a leakage current of the thin film transistor is changed accordingly, and the transmission time which required by the potential change is therefore changed. The read-out switch transmits said potential to a data read-out line in order to calculate the intensity of the ambient light from the transmission time. The LCD of this invention includes a plurality of capacitors, a plurality of read-out switches and a processing module.

### FIELD OF THE INVENTION

The present invention relates to a liquid crystal display, and more particularly to a liquid crystal display with an ambient light sense function.

### BACKGROUND OF THE INVENTION

At present, information technology is well developed in our society, and the electronic display instruments are used extensively in industries and homes to serve as an interactive media between users and various electronic instruments. Since liquid crystal display comes with the features of light weight and low power consumption, it has become an indispensable one to our daily life. The liquid crystal display comprises a backlight module as a light source, a liquid crystal layer and several thin film transistors for controlling the deflection angle of liquid crystals, wherein the thin film transistor is one of field-effect transistors which primarily was made by depositing different thin films, such as an active layer, a dielectric layer and a metal electrode layer over a substrate. The thin film transistor also comes with the features of small volume and light weight, and thus thin film transistor is commonly used in liquid crystal display.

However, the power consumption of a liquid display panel (or screen) of a notebook computer still occupies one-third of the overall power consumption of the notebook computer. Thus, it is a long-term objective for manufacturers to develop a power-saving liquid crystal display (or screen) for users, as science or technology advances. Therefore, the way of using the traditional manufacturing method should be reviewed carefully without direct adopting. For example, the brightness of the screen in the past is produced in above a certain level of intensity to avoid the LCD screen being dimmed under a bright ambient light, while such arrangement consumes lots of power, and the bright screen may irritate user's eyes.

To save power, a new-generation liquid crystal display has come with a feature of adjusting itself intensity of a light emission to provide the most suitable brightness for users in accordance with the brightness of an ambient light In other words, the new-generation liquid crystal display can correct its own brightness according to the brightness of the ambient light source to achieve the goal of providing sufficient brightness without irritating users' eyes.

One of the methods of detecting ambient light are disclosed in prior arts is U.S. Pat. No. 7,218,048. Referring to FIG. 1 for a schematic view of a structure of a prior art electronic display device, the cited prior art adopts a photo sensing diode (or PIN diode) as a photo sensing element. This component can produce a leakage current of a different intensity under the projection of a light of a different intensity, and the prior art uses this feature to detect the brightness of the environmental surrounding. However, the level of leakage current is approximately equal to 8˜10 amperes as shown in FIG. 2, and thus an external circuit cannot read such a small signal to correct the brightness. Therefore, it is necessary to connect a plurality of photo sensing diodes in parallel as shown in FIG. 3 in order to connect a plurality of transistors (Ts) in parallel for accumulating a current flow and achieve the detection range of the external circuit. Obviously, the prior art requires a very large detecting area; while it not only increased the non-displaying area of a screen, but also increased the cost amount.

In view of the the prior art, the inventor of the present invention based on years of experience in the related industry to conduct extensive researches and experiments, and finally developed a liquid crystal display with an ambient light sense function and its method to overcome the shortcomings of the prior art.

### SUMMARY OF THE INVENTION

It is a primary objective of the present invention to provide a liquid crystal display with an ambient light sense function and its method to overcome the shortcomings of the prior art especially in its too-large sensing area and its too-high cost amount.

Another objective of the present invention is to provide an ambient light sense method applicable for a thin film transistor, and the method comprises the steps of: coupling a capacitor to a source electrode of a thin film transistor; reducing the electric charges of the capacity according to a leakage current of the thin film transistor; calculating a transmission time of a potential from the reduction of electric charges; and finally calculating the intensity of the ambient light according to the transmission time.

A further objective of the present invention is to provide an ambient light sense circuit applicable for a pixel structure, and the circuit comprises: a thin film transistor, having an intensity of leakage current directly proportional to the intensity of the ambient light; a capacitor, with an end coupled to a source electrode of the thin film transistor, and another end coupled to the ground; and a read-out switch, coupled between the source electrode of the thin film transistor and a data read-out line. If the ambient light changes, the leakage current of the thin film transistor is changed accordingly, and a transmission time which required by a the potential change is therefore calculated, wherein the read-out switch transmits said potential to a data read-out line, and the external circuit calculates the intensity of the ambient light according to the transmission time of the capacitor.

The present invention further provides a liquid crystal display that can adjust the brightness of an illuminating module according to the ambient light, and comprises a plurality of capacitors, coupled to a plurality of pixels of the liquid crystal display; a plurality of read-out switches, coupled between the capacitor and a data read-out line, for reading said potential; and a processing module, for calculating the intensity of the ambient light according to the transmission time which required by the potential change, in order to adjust the brightness of the illuminating module.

In view of the description above, the liquid crystal display with an ambient light sense function and its method in accordance with the present invention have the following advantages:

(1) The sensing area can be reduced effectively.

(2) The power consumption can be lowered.

(3) The potential can be outputted by a digital signal.

(4) The production cost can be reduced.

To make it easier for the examiner to understand the object, shape, structure, device, characteristics and functions of this invention, the specification accompanied by the drawings is described as follows.

### BRIEF DESCRIPTION OF THE DRAWINGS

FIG. 1 is a schematic view of a structure of a prior art electronic display device;

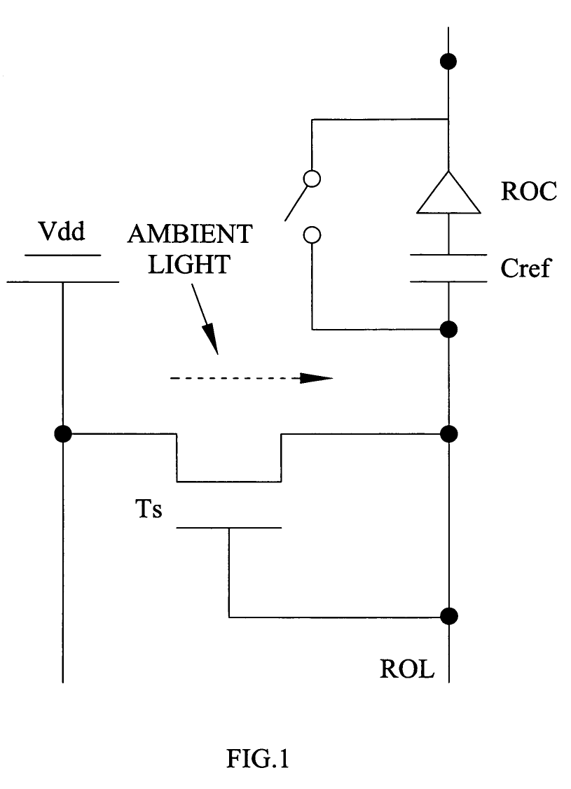

FIG. 2 is a schematic view of a leakage current of a prior art electronic display device;

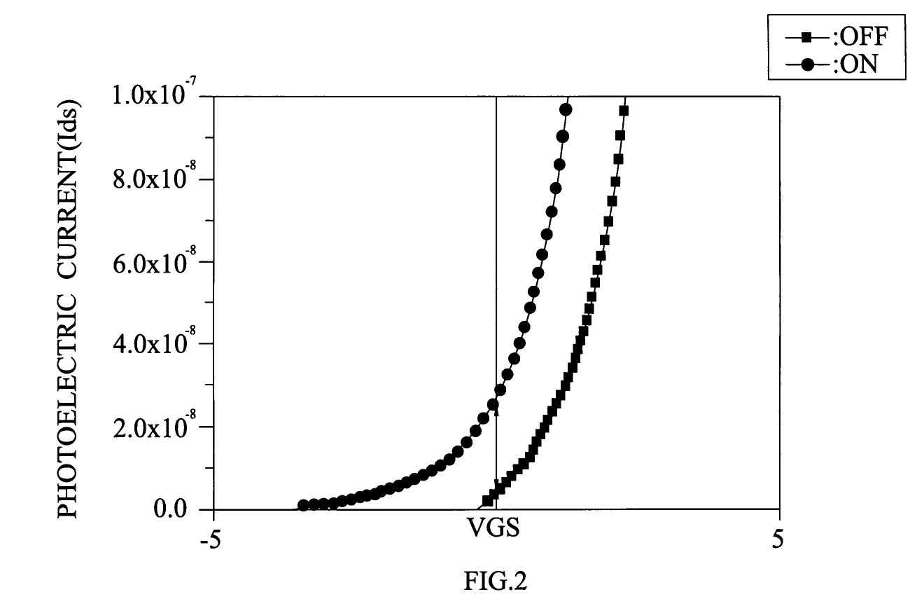

FIG. 3 is a schematic view of a portion of a prior art electronic display device;

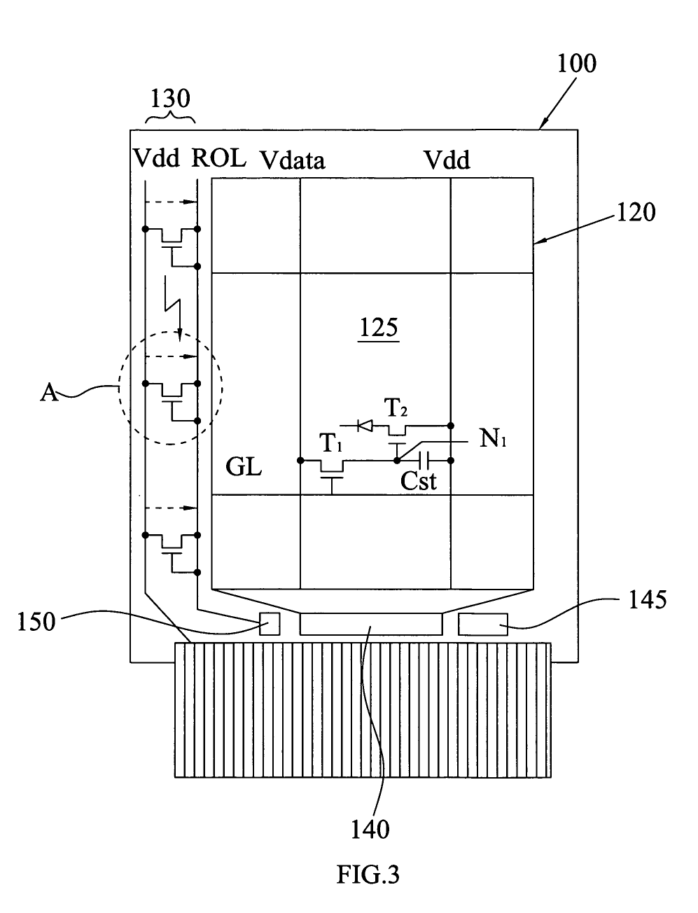

FIG. 4 is a flow chart of an ambient light sense method of the present invention;

FIG. 5 is a schematic view of a structure of an ambient light sense circuit in accordance with the present invention;

FIG. 6 is a schematic view of another structure of an ambient light sense circuit in accordance with the present invention;

FIG. 7 is a schematic view of a pixel structure of an ambient light sense circuit in accordance with the present invention;

FIG. 8 is a schematic view of another pixel structure of an ambient light sense circuit in accordance with the present invention;

FIG. 9 is a waveform diagram of an ambient light sense circuit in accordance with the present invention;

FIG. 10 is a schematic view of a liquid crystal display in accordance with the present invention;

FIG. 11 is a simulated waveform diagram of the present invention; and

FIG. 12 is a waveform diagram of an actual measurement in accordance with a preferred embodiment of the present invention.

### DETAILED DESCRIPTION OF THE PREFERRED EMBODIMENTS

The liquid crystal display with an ambient light sense function and its method in accordance with the present invention are described in details together with related drawings as follows. For simplicity, like reference numerals of the following embodiments refer to like parts of the invention.

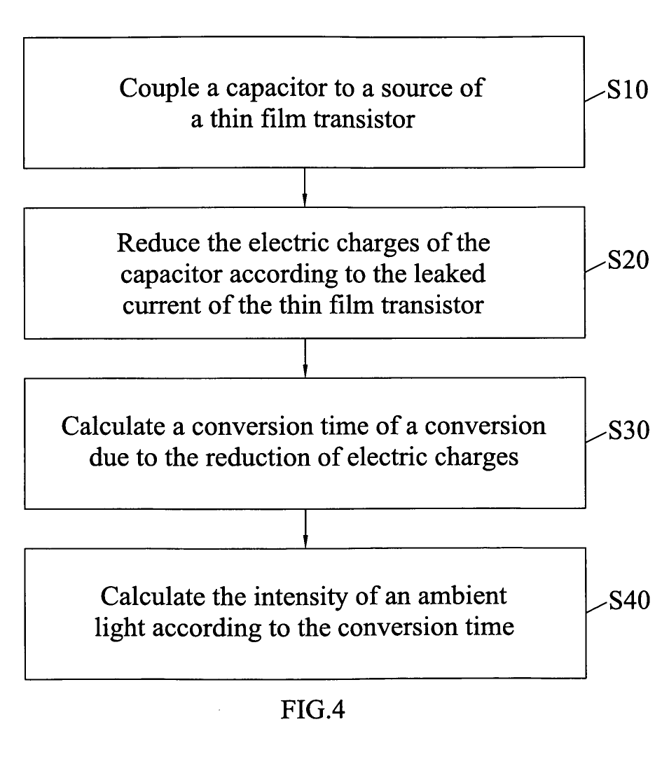

Referring to FIG. 4 for a flow chart of an ambient light sense method of the invention, the method comprises the steps of: coupling a capacitor to a source electrode of a thin film transistor (Step S10), wherein the leakage current of the thin film transistor is directly proportional to the intensity of the ambient light, and thus the electric charges of the capacitor are reduced according to the leakage current of the thin film transistor (Step S20); calculating a transmission time for transmitting the potential from high to low from the reduction of electric charges (Step S30); and finally calculating the intensity of the ambient light according to the transmission time (Step S40).

In other words, the method to manufacture a thin film transistor can be set by the present panel manufacturing processes, to store electric charges in a capacitor firstly, and then use the thin film transistor features of the leakage current varies in different intensity of light source, to make a difference of time required when losing electric charges in the capacitor. Therefore, if the ambient light is stronger, the time for transmitting the potential is therefore shorter. Besides, the clock of a scan line on the panel is used here to drive a circuit to read said potential signal, so as to achieve the goal of detecting the intensity of the ambient light. Since the components adopted in this method match with the present existing manufacturing process, the liquid crystal display of the invention can be manufactured by the present existing panel manufacturing process without changing the manufacturing process to achieve the goal of lowering the manufacturing cost.

In the method of a preferred embodiment, a data read-out line is provided for obtaining said potential. To digitize the potential signal, this embodiment also connects a logic gate to the data read-out line. In other words, after the potential is fed into a logic NOT gate, the potential is outputted to the data read-out line. To make it easy to identify the outputted signal, an inverting amplifier is added to the logic NOT gate. Further, a read-out switch can be coupled between the data read-out line and the capacitor, and the existing scan line signal of a liquid crystal panel is used to sequentially start a plurality of read-out switches, so that the data read-out line can obtain a plurality of electric potential signals of the capacitors sequentially. To provide a better interactive relation between the leakage current of the thin film transistor and the ambient light, the thin film transistor of the embodiment adopts an amorphous silicon thin film transistor or a polysilicon thin film transistor.

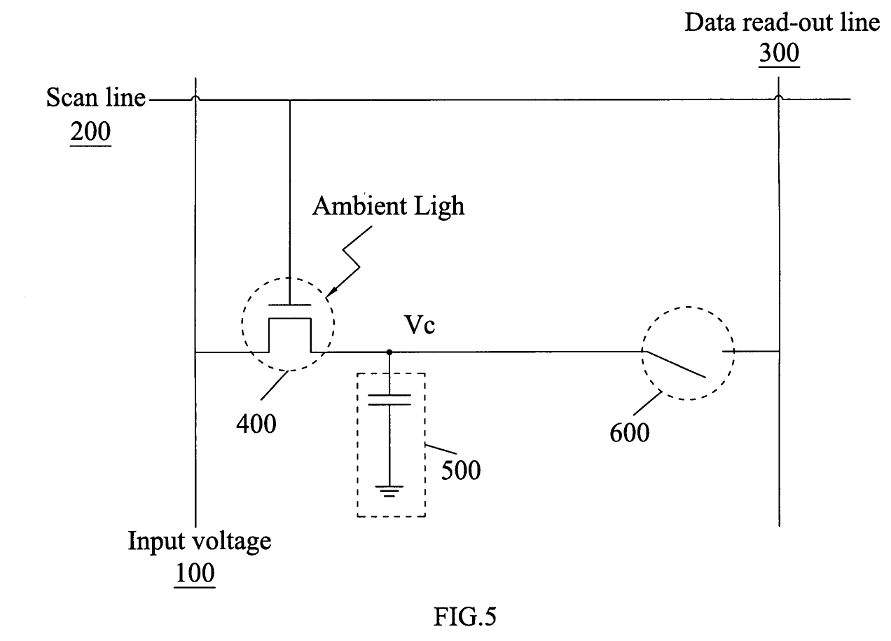

Referring to FIG. 5 for a schematic view of a structure of an ambient light sense circuit in accordance with the present invention, the circuit is applicable for a pixel structure and comprises an input voltage 100, a scan line 200, a data read-out line 300, a photo sensing thin film transistor 400, a capacitor 500 and a read-out switch 600. Their connections are shown in FIG. 5 and thus will not be described further here. After the scan line 200 turns on the photo sensing thin film transistor 400, the input voltage 100 pulls the potential Vc 500 to a high potential. If the scan line 200 turns off the photo sensing thin film transistor 400, the photo sensing thin film transistor 400 will produce a leakage current under the projection of an ambient light, and the magnitude of the leakage current is directly proportional to the intensity of the ambient light. The leakage current will gradually consume the electric charges which stored in the capacitor 500, and the potential Vc 500 will drop accordingly. And then, the read-out switch 600 transmits the change of the potential Vc to the data read-out line 300, so that an external circuit can estimate the intensity of the ambient light based on the time required for transmitting the potential Vc from high potential to low potential. The aforementioned photo sensing thin film transistor 400 can be an amorphous silicon thin film transistor or a polysilicon thin film transistor to achieve a better sensing effect of the ambient light.

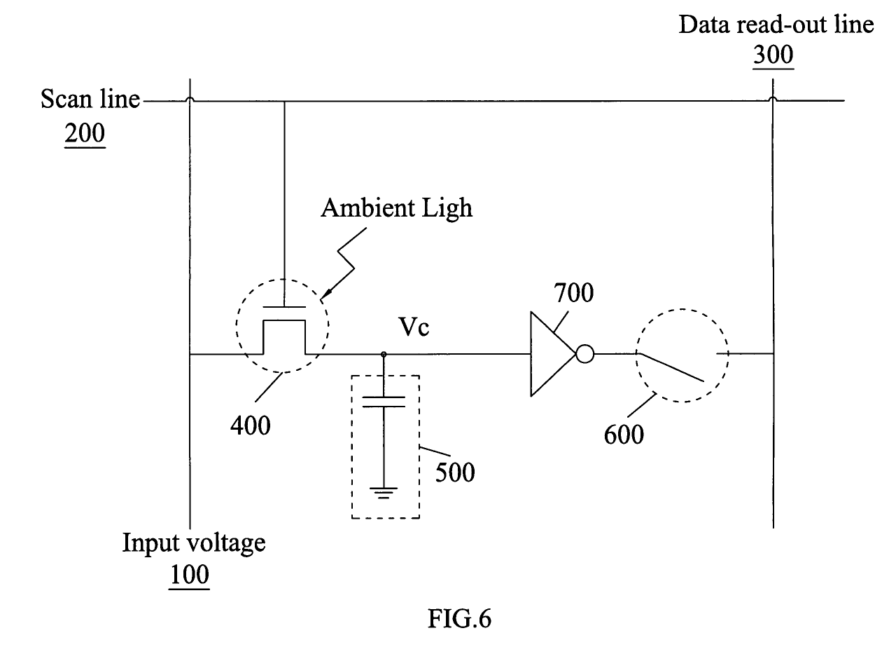

Referring to FIG. 6 for a schematic view of another structure of an ambient light sense circuit in accordance with the present invention, an inverting amplifier 700 is coupled between the capacitor 500 and the read-out switch 600. The potential Vc 500 can be converted into an inverted and amplified digital signal by the inverting amplifier 700 to achieve the advantages of a low level of complexity and a high level of precision, so as to facilitate the external circuit to determine the intensity of the ambient light.

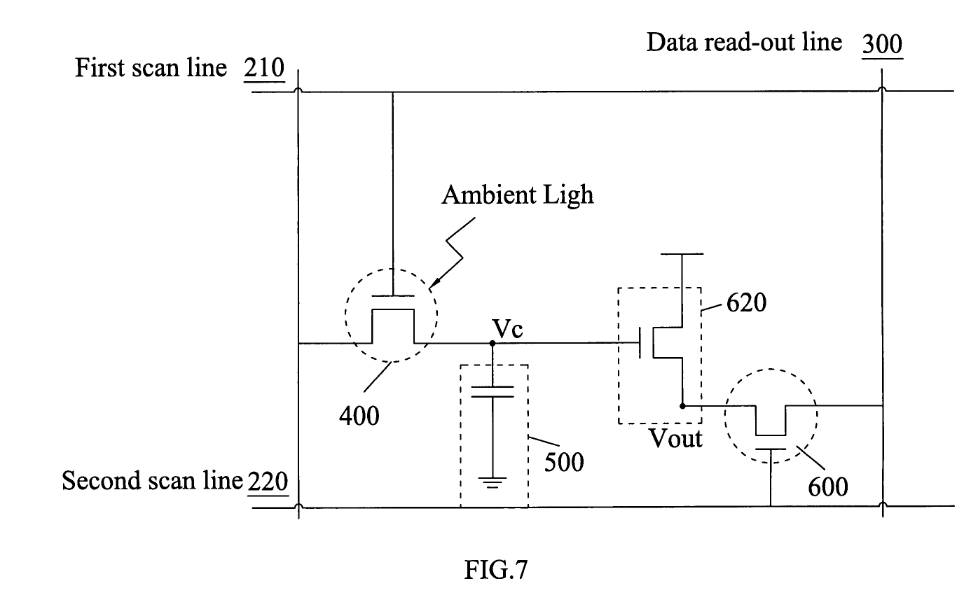

Referring to FIG. 7 for a schematic view of a structure of an ambient light sense circuit in accordance with a preferred embodiment of the present invention, the read-out switch 600 is a thin film transistor switch 610. In addition, a pre-stage of the read-out switch 600 can be coupled to a signal amplification transistor 620 for amplifying the output voltage Vout.

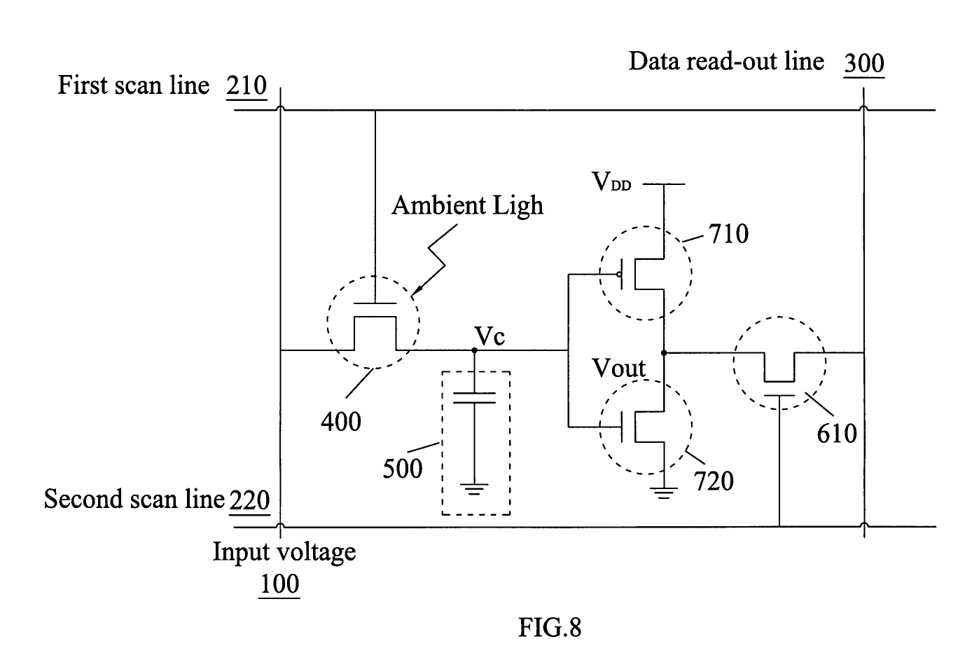

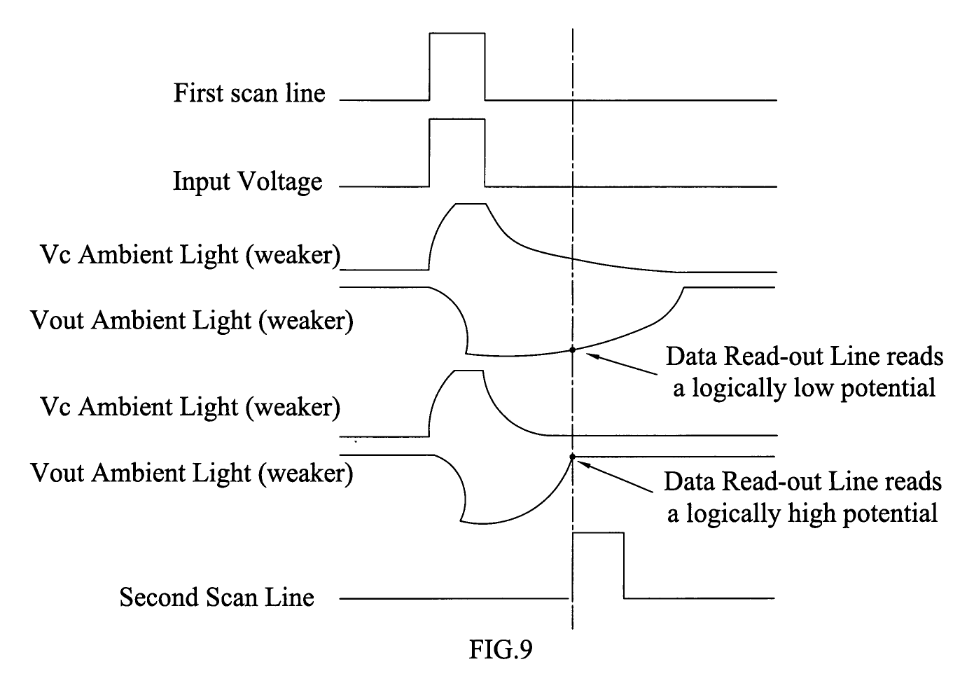

Referring to FIG. 8 for a schematic view of a structure of an ambient light sense circuit in accordance with another preferred embodiment of the present invention, the inverting amplifier 700 comprises a p-type thin film transistor 710 and a n-type thin film transistor 720, and its operating principle is a prior art, and thus will not be described in details here. The read-out switch 600 is comprised of a thin film transistor switch 610 and controlled at a second scan line 220. Therefore, all components in this embodiment can be achieved by the present existing manufacturing procedure. The scan signals of a liquid crystal display are fed into a first scan line 210 and a second scan line 220 to start a photo sensing thin film transistor 400 and a thin film transistor switch 610 sequentially. Therefore, the data read-out line 300 can obtain the waveforms of the output voltage Vout sequentially. In FIG. 9, the data read-out line 300 uses a scan signal as a basic frequency to calculate the transmission time of the output voltage signal. For example, the output voltage Vout within one basic frequency is converted from high potential to low potential under the projection of a strong light. If the ambient light becomes weaker, the output voltage Vout may be converted in 2˜3 basic frequencies.

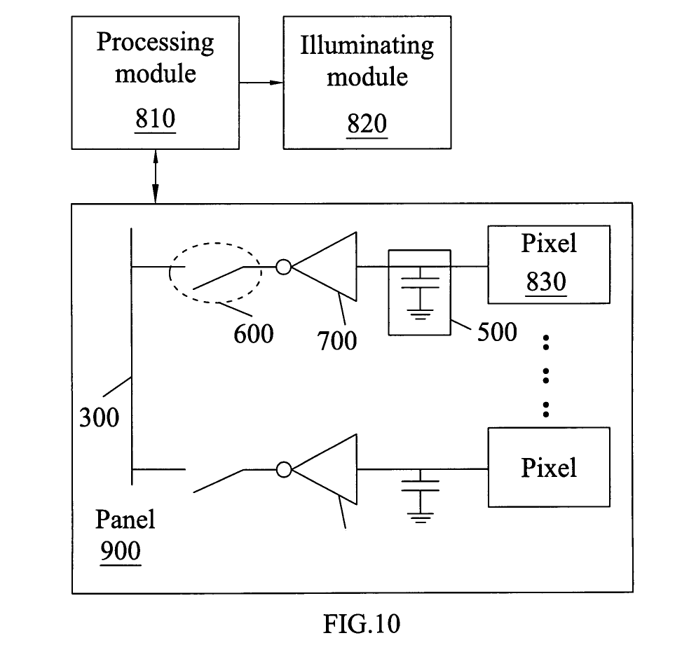

Referring to FIG. 10 for a schematic view of a structure of a liquid crystal display in accordance with the present invention, the invention comprises a processing module 810, an illuminating module 820, a panel 900, a data read-out line 300, a plurality of read-out switches 600, a plurality of capacitors 500 and a plurality of pixels 830. As we all know, the panel 900 has a plurality of pixel structures, and users can connect the capacitor 500 and the read-out switch 600 according to the requirements of the manufacturing procedure, or the consideration of cost on a portion or the whole of the pixels 830. If an ambient light is projected onto a thin film transistor with the pixels 830 to produce a leakage current, the potential 500 keeps on dropping as the electric charges of the capacitor 500 are removed according to the leakage current. The processing module 810 starts the read-out switch 600 to transmit the potential signals 500 to a data read-out line 300 sequentially. After the processing module 810 obtains a transmission time of the potential represented by the ambient light through the data read-out line 300, the intensity of the illuminating module 820 such as the backlight module of the capacitor 500 can be adjusted to achieve the power saving effect. To amplify the potential signals 500 in order to improve the identification level and digitize the transmission time of the electric potential, the capacitor 500 can be coupled to a logic NOT gate such as an inverting amplifier 700.

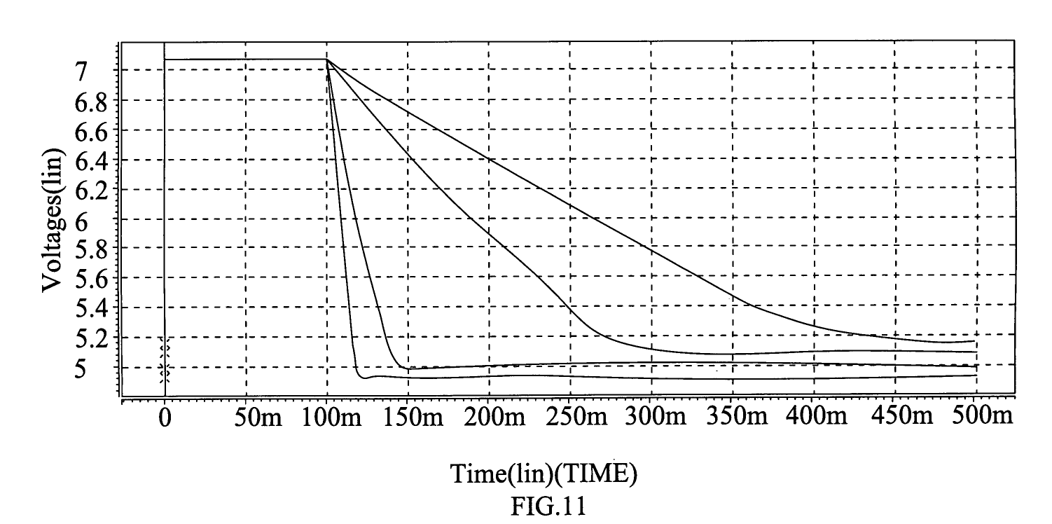

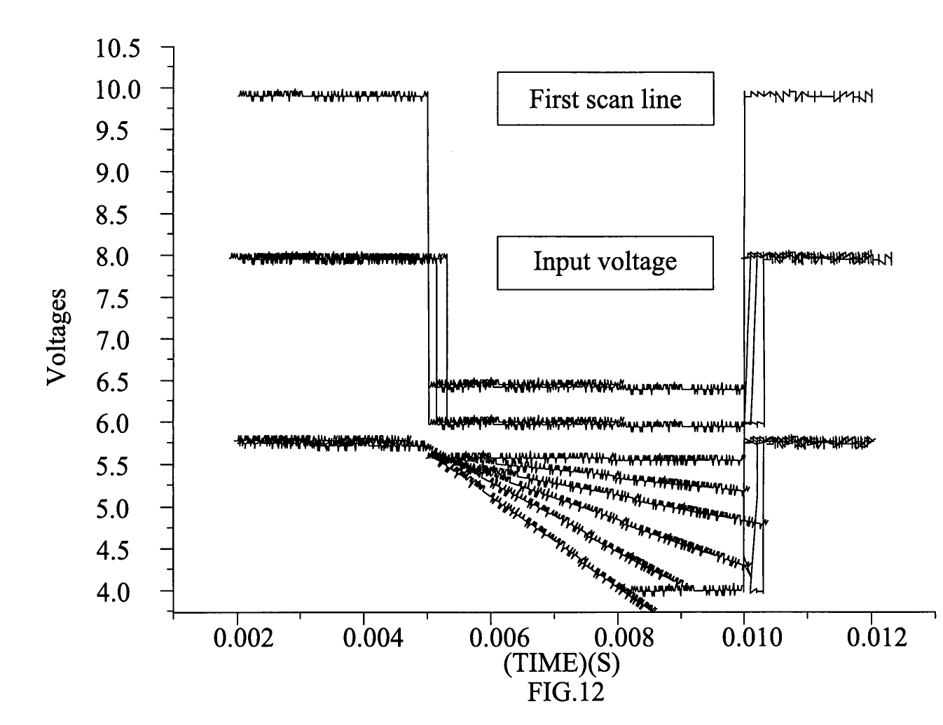

Referring to FIG. 11 for a simulated waveform diagram of the present invention, the simulated waveform simulates the intensity of the leakage current of the TFT under the projection of ambient light of a different intensity. Referring to FIG. 12 for an actual measured waveform diagram of a preferred embodiment of the present invention, the status of a leakage current of the TFT is projected by an ambient light of a different intensity after a first scan line signal and an input voltage signal are actually measured.

Although the invention uses the magnitude of a leakage current of the thin film transistor that is directly proportional to the intensity of the ambient light to detect a change of ambient light, yet the invention is not limited to such arrangement only. If the magnitude of leakage current of the thin film transistor is indirectly proportional to the intensity of the ambient light, the objective of detecting the ambient light in accordance with the present invention can be achieved without departing the spirit of the invention of using the leakage current of the thin film transistor to detect the ambient light. Therefore, the aforementioned thin film transistor is preferably an amorphous silicon thin film transistor or a polysilicon thin film transistor, but the invention is not limited to such arrangement.

In summation of the description above, the present invention of the liquid crystal display with an ambient light sense function and its method has the following features:

1. The thin film transistor produced by the present manufacturing process can be used as an ambient light sensor.

2. The sensing area can be reduced.

3. The power consumption can be decreased.

4. The production cost can be lowered.

5. The potential can be outputted by a digital signal.

While the invention has been described in terms of specific embodiments of the present invention, it is not limited to such detail since numerous modifications and variations could be made thereto by those skilled in the art without departing from the scope and spirit of the present invention. Therefore, the features and advantages of the present invention will be set forth in the claims.

What is claimed is:

1. An ambient light sense method, applicable for a thin film transistor, comprising the steps of:
coupling a capacitor to a source electrode of the thin film transistor;
reducing electric charges of the capacitor according to a leakage current of the thin film transistor;
calculating a transmission time which required by a potential change from the reduction of electric charges; and
calculating an intensity of the ambient light according to the transmission time.

2. The ambient light sense method of claim 1, further comprising a step of coupling a logic NOT gate to the capacitor, for transmitting said potential into a digital signal.

3. The ambient light sense method of claim 2, wherein the logic NOT gate is an inverting amplifier.

4. The ambient light sense method of claim 1, further comprising a step of coupling a data read-out line to the capacitor, for outputting said potential.

5. The ambient light sense method of claim 4, further comprising a step of coupling a read-out switch between the capacitor and the data read-out line, for reading said potential.

6. The ambient light sense method of claim 1, wherein the thin film transistor is an amorphous silicon thin film transistor or a polysilicon thin film transistor.

7. An ambient light sense circuit, applicable for a pixel structure, comprising:
a thin film transistor, with a leakage current directly proportion to the ambient light;
a capacitor, with an end coupled to a source electrode of the thin film transistor, and another end coupled to a ground; and
a read-out switch, coupled between a source electrode of the thin film transistor and a data read-out line;
thereby, if the ambient light changes, the leakage current of the thin film transistor is changed accordingly, so that a transmission time which required by a potential change is therefore changed, wherein the read-out switch transmits said potential to the data read-out line.

8. The ambient light sense circuit of claim 7, further comprising a logic NOT gate, coupled between the capacitor and the read-out switch, for transmitting said potential into a digital signal.

9. The ambient light sense circuit of claim 8, wherein the logic NOT gate is an inverting amplifier.

10. The ambient light sense circuit of claim 7, wherein the thin film transistor is an amorphous silicon thin film transistor or a polysilicon thin film transistor.

11. A liquid crystal display, for adjusting a brightness of an illuminating module according to an ambient light, comprising:
a plurality of capacitors, coupled to a plurality of pixels of the liquid crystal display;
a plurality of read-out switches, coupled between the capacitors and a data read-out line, for reading said potential; and
a processing module, calculated an intensity of the ambient light in accordance with the transmission time which required by a potential change, for adjusting the brightness of the illuminating module.

12. The liquid crystal display of claim 11, further compraising a plurality of logic NOT gates, coupled between the capacitors and the read-out switches, for transmitting said potential into a digital signal.

13. The liquid crystal display of claim 12, wherein the logic NOT gate is an inverting amplifier.

14. The liquid crystal display of claim 11, wherein the illuminating module is a backlight module.
